(19) United States
(12) Patent Application Publication
(10) Pub. No.: US 2005/0021525 A1
(43) Pub. Date: Jan. 27, 2005

(54) Data carrier having power dependent data processing modes

(76) Inventors: Peter Thueringer, Graz (AT); Stefan Posch, Graz (AT)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/494,924

(22) PCT Filed: Nov. 8, 2002
(86) PCT No.: PCT/IB02/04674

(30) Foreign Application Priority Data
Nov. 9, 2001 (EP) 01000610.4

(51) Int. Cl. G06F 17/00

(52) U.S. Cl. 707/100

(57) ABSTRACT

In a data carrier (1) that, using signals (S) occurring at transmission means (3), is arranged to make available power for supplying parts of its circuit (2) with power, data processing means (16) are provided for processing data (CD, MD, DD, RD) in at least two different modes of processing, the power made available being dependent on the mode of processing being performed at the time, and also provided are influencing means (18) that are arranged to influence the data processing means (16) in respect of the latter's mode of processing in the light of the power available.

The invention relates to a data carrier having transmission means for transmitting signals and having a circuit, which circuit has at least one connection to which the transmission means are connected and which circuit has the parts listed below, namely: power supply means that, using a signal occurring at the transmission means, are arranged to supply parts of the circuit with power, and data processing means that are provided for the processing of data in at least two different modes of processing and by means of which data is able to be processed when the power made available by the power supply means exceeds a minimum value, the power to be made available by the power supply means being dependent on the mode of processing being performed at the time.

The invention further relates to a circuit for a data carrier, which data carrier has transmission means for transmitting signals, which circuit has at least one connection to which the transmission means can be connected and which circuit has the following parts listed below, namely: power supply means that, using a signal occurring at the transmission means, are arranged to supply parts of the circuit with power, and data processing means that are intended for the processing of data in at least two different modes of processing and by means of which data is able to be processed when the power to be made available by the power supply means exceeds a minimum value, the power made available by the power supply means being dependent on the mode of processing being performed at the time.

A data carrier of the kind defined in the first paragraph above and a circuit of the kind defined in the second paragraph above have developed by the applicant and put on the market in connection with an electronic travel ticket and are therefore known.

The known data carrier that has the known circuit is designed for non-contacting communication with a communications station and has as a first part of its circuit a microprocessor that forms data processing means. What are provided in the known data carrier as a second part of the circuit are memory means that are implemented in the form of an EEPROM and that are intended for the storage of transport data representing transport units. By means of the microprocessor the transport data can be processed under programmed control. When processing the transport data, the microprocessor performs two modes of processing, namely a first mode of processing in which the transport data is manipulated by the microprocessor, and a second mode of processing in which the microprocessor accesses the memory means in order to read the transport data out of the memory means or to write it to the memory means. In this case the power supply means must, or must be able to, make more power available in the second mode of processing than in the first mode of processing.

In the case of the known data carrier, there is the problem that, even though safety measures are taken for protection against an unwanted loss of data when processing the transport data, namely the time-consuming creation and checking of safety copies of the transport data, which takes up additional memory space, it is still possible for data to be lost. A data loss of this kind may for example occur if the data carrier is introduced into a communications area of the communications station and the power supply means at first make available sufficient power to start the processing of the data but after this the data carrier is moved out of the communications area again, which means that the power supply means can no longer make sufficient power available and as a result the processing of the transport data cannot be successfully completed for lack of power.

It is an object of the invention, in a data carrier of the kind defined in the first paragraph above and in an electrical circuit of the kind defined in the second paragraph above, to overcome the problem described above and to provide an improved data carrier and an improved electrical circuit.

To achieve the object defined above, provision is made in accordance with the invention, in a data carrier of the kind defined in the first paragraph above, for influencing means to be provided that are provided for influencing the data processing means in respect of the latter's mode of processing in the light of the power available at the power supply means.

To achieve the object defined above, provision is made in accordance with the invention, in a circuit of the kind defined in the second paragraph above, for influencing means to be provided that are provided for influencing the data processing means in respect of the latter's mode of processing in the light of the power available at the power supply means.

What is achieved in an advantageous way by the making of the provisions according to the invention is that processing of data can be performed in that processing mode that is commensurate with the power available at the power supply means. This also gives the advantage that it is possible to avoid processing data in a mode of processing that would require the power supply means to cover a power demand that exceeded the power available at the power supply means. It also gives the advantage that, on the basis of the power currently available, it becomes possible to influence the data processing means in a predictive manner with regard to the feasibility of a mode of processing. Yet another advantage that it gives is that any loss of data due to a lack of power when processing data can be reliably avoided.

In a solution according to the invention it has further proved advantageous if the influencing means are arranged to influence the data processing means in respect of the speed at which they process data. This gives the advantage that the influencing of the data processing means in respect of the speed at which they process data can be carried out directly with the help of the influencing means, by which means it is ensured that optimum use is made of the power available in the power supply means because the speed of processing is a crucial parameter of a basic demand for power.

In a solution according to the invention it has further provided advantageous if the influencing means are arranged to influence the data processing means in respect of the latter's ability to communicate with parts of the circuit provided for communicating with the data processing means. This gives the advantage that it becomes possible reliably to avoid a power demand that occurs during communication by the data processing means with a part of the circuit, and that may, where appropriate, be possible after such communication, and that exceeds the power available at the power supply means.

In a solution according to the invention, it has further provided advantageous if the influencing means are arranged to monitor at least one parameter of the power supply means, which parameter is the power available at the power supply means, and if the influencing means are arranged to decide whether, on the basis of the parameter monitored, the data processing means need to be influenced in respect of their mode of processing. This gives the advantage that, with the help of the influencing means, it is possible to obtain an objective and undistorted decision as to whether, on the basis of the power available in the power supply means, the mode of processing needs to be influenced, because the influencing means are themselves arranged to monitor the parameter representing the power available. It also gives the advantage that operation of the influencing means unaffected by disruptive factors is obtained and that on this basis the mode of processing can virtually always be influenced correctly in relation to the power available.

These and other aspects of the invention are apparent from and will be elucidated with reference to an embodiment described hereinafter, but to which the invention is not limited.

In the drawings:

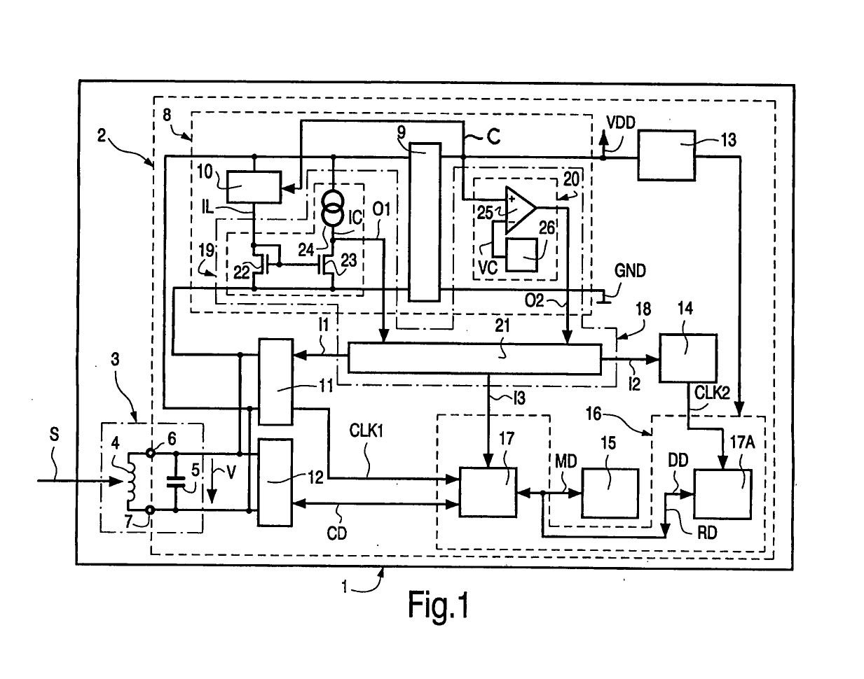

FIG. 1 shows, schematically in the form of a block diagram, a data carrier in accordance with one embodiment of the invention.

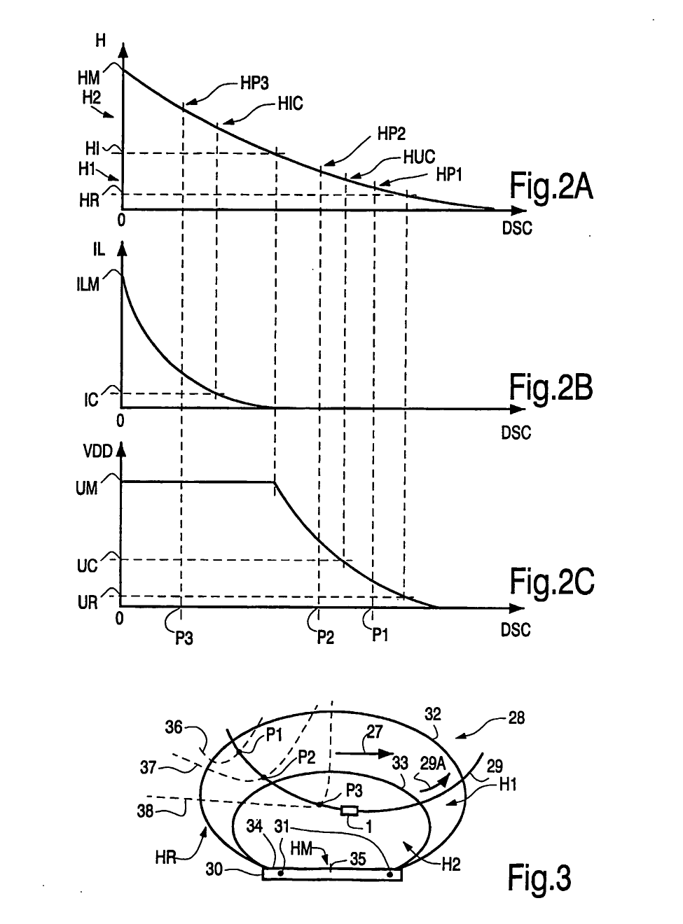

FIG. 2 shows, in the form of three graphs, the relationship between the field strength of signals by means of which power can be fed to the data carrier shown in FIG. 1, and two parameters of the data carrier that represent the power available for processing data.

FIG. 3 shows, schematically, a movement of the data carrier shown in FIG. 1 along a path of movement within a communications area of a communications station in an example of application of the data carrier.

In FIG. 1 is shown a data carrier 1 that has an integrated electrical circuit 2. The data carrier 1 further has transmission means 3 that are arranged to transmit signals S, which signals S can be emitted or received by a communications station (not shown in FIG. 1). Communications data CD can be exchanged between the communications station and the data carrier 1 with the help of signals S. Power to supply the circuit 2 electrically can also be fed to the data carrier 1 with the help of signals S. The transmission means 3 have a communications coil 4 arranged outside the circuit 2 and a capacitor 5 arranged inside the circuit 2, the communications coil 4 and the capacitor 5 being connected in parallel with one another and forming a resonant circuit that is tuned to the frequency of the signals S. It may further be mentioned that the capacitor 5 may also be arranged outside the electrical circuit 2. Another point that may be mentioned is that the transmission means may also be arranged for the capacitive transmission of signals.

The circuit 2 has a first connection 6 and a second connection 7, to which connections 6 and 7 the transmission means 3 are connected.

The circuit 2 also has power supply means 8 that, by using the signals S that occur at the transmissions means 3 between the two connections 6 and 7, are arranged to generate a supply voltage VDD and that, by using the supply voltage VDD generated, are arranged to supply parts of circuit 2 with power. For this purpose, the power supply means 8 have a supply voltage generating stage 9 to which the signals S occurring at the transmission means 3 can be fed in the form of an input voltage V. The supply voltage generating stage 9 is arranged to rectify the input voltage V. The supply voltage generating stage 9 also has a storage capacitor (not shown in FIG. 1) for smoothing the rectified input voltage V. The supply voltage generating stage 9 is further arranged to emit the supply voltage VDD so generated in relation to a reference potential GND.

The power supply means 8 also have a supply voltage limiting stage 10 that is connected, on the input side of the supply voltage generating stage 9, across the first connection 6 and the second connection 7 of transmission means 3 and that is arranged to limit the supply voltage VDD to a maximum supply voltage value UM of 5 volts. For this purpose, the supply voltage limiting stage 10 has a limiting transistor (not shown in FIG. 1) and a control stage (also not shown in FIG. 1) to control the conductivity of the limiting transistor, it being possible for the supply voltage VDD to be fed to the control stage by means of a connection C. By means of supply voltage limiting stage 10, it is possible to generate, as a function of the value of supply voltage VDD, a limiting current IL with which excess power can be dissipated.

In what follows and with reference to FIG. 2, the relationship will be elucidated between a field strength H occurring at transmission means 3—i.e. the power transmitted to data carrier 1 with the help of the signals S—and the limiting current IL and supply voltage VDD. FIG. 2A shows in the form of a graph a curve for the field strength H as a function of a distance DSC between the data carrier 1 and the communications station. FIG. 2B shows a curve for the limiting current IL in a similar way to FIG. 2A and FIG. 2C shows a curve for the supply voltage VDD, also in a similar way to FIG. 2A.

When the value of the distance DSC is zero, the value of the field strength H is at a maximum HM and, as the distance DSC increases, its value declines to a point where a reset field strength value HR is reached at which the power transmitted to data carrier 1 with the help of the signals S is at a minimum value and the supply voltage VDD generated by means of power supply means 8 is at a reset voltage value UR. When the data carrier 1 approaches the communications station, the value H of the field strength, starting at the reset field strength value HR, rises in the opposite direction to distance DSC until the field strength H is at its maximum value HM.

Between the reset field strength value HR and an intermediate field strength value HI, the supply voltage VDD increases with increasing field strength H from the reset voltage value UR to a maximum supply voltage value UM. Between the field strength values HR and HI, the value of the limiting current IL is zero. Hence there is between the field strengths HR and HI a first field strength range H1 in which there is sufficient power to generate the supply voltage VDD, the value of which latter is higher than the reset supply voltage value UR or equal to the reset supply voltage value UR, the value of the supply voltage VDD being however variable as a function of the distance DSC or of a power demand from the circuit 2 that is being supplied with power.

Between the intermediate field strength value HI and the maximum field strength value HM, the limiting current IL increases as the field strength H increases and in the event of an approach of this kind its value rises from zero to a maximum limiting current value ILM. Between the field strength values HI and HM, the supply voltage VDD is at its constant maximum supply voltage value UM. Hence there is between the field strength values HI and HM a second field strength range H2 in which, by means of limiting current IL, excess power is converted into heat. In this second field strength range H2, the value of limiting current IL is dependent both on distance DSC and on a power demand from the parts of circuit 2 that are being supplied.

The data carrier shown in FIG. 1 also has parts of the circuit that need to be supplied with power, namely processing clock-signal generating means 11, modulating/demodulating means 12, resetting means 13, calculating clock-signal generating means 14, memory means 15 and data processing means 16, which data processing means 16 have a processing stage 17 implemented in the form of a microprocessor and a calculating stage 17A implemented in the form of a mathematical co-processor, a more detailed description of means 11, 12, 13, 14 and 15 being given below.

The processing clock-signal generating means 11 are arranged to receive the input voltage V and to generate a processing clock signal CLK1 and transmit it to processing stage 17. For the purpose of generating the processing clock-signal CLK1, the processing clock-signal generating means 11 are so arranged that they act to derive an intermediate signal whose frequency is approximately 13 MHz from the input voltage V and to controllably divide the frequency of the intermediate signal by a figure of 8, by which means a first processing frequency is defined, and by a figure of 4, by which means a second processing frequency is defined. The processing clock-signal generating means 11 are also arranged to receive a first influencing signal I1 by means of which the controllable division of the frequency of the intermediate signal is caused to take place to the first processing frequency or the second processing frequency.

The modulating/demodulating means 12 are arranged to receive the communications data CD that can be received from processing stage 17 and to amplitude modulate the signals S occurring at the transmission means 3 in accordance with the communications data CD, by which means the communications data CD can be transmitted to the communications station. The modulating/demodulating means 12 are also arranged to demodulate the input voltage V representing the signals S and hence to obtain the communications data CD that is transmitted to data carrier 1 by means of the signals S and to transmit this communications data CD to processing stage 17.

The resetting means 13 are arranged to receive the supply voltage VDD and, as a function of the value of supply voltage VDD compared with the reset supply voltage value UR, to generate a reset signal R and transmit it to data processing means 14.

The calculating clock-signal generating means 14 are arranged to generate a calculating clock-signal CLK2 and to transmit it to the calculating stage 17A. For this purpose, the calculating clock-signal generating means 14 have an oscillator stage (not shown in FIG. 1) that is arranged to be startable and stoppable and, in its started state, to generate the calculating clock-signal CLK2 that has a calculating frequency of 32 MHz. The calculating clock-signal generating means 14 are also arranged to receive a second influencing signal I2 by means of which the oscillator stage can be stopped or started.

The memory means 15 are implemented in the form of an EEPROM and are provided for the storage of memory data MD. For this purpose, the memory means 15 are also arranged to communicate with processing stage 17, i.e. to receive memory data MD from processing stage 17 and to transmit stored memory data MD to processing stage 17 when processing stage 17 accesses memory means 15. In a quiescent state, i.e. when no communication is taking place, memory means 15 produce a memory means quiescent power demand. The memory means 15 are also arranged to write memory data MD to their storage locations, in temporal succession to the reception of the memory data MD or in other words after the memory data MD has been transmitted by processing stage 17 to memory means 15 for the purpose of having the memory data MD stored. Due to the writing operation, a writing power demand is caused in memory means 15 that is greater than the memory means quiescent power demand.

The processing stage 17 is arranged to communicate the communications data CD to the modulating/demodulating means 12 and to communicate the memory data MD to the memory means 15, in which case there is a first communication power demand at the memory means 15 and at the processing stage 17 in the event of such communication. Processing stage 17 is also arranged to communicate the calculation data DD to the calculating stage 17A, in which case there is a second communication power demand at calculating stage 17A and at processing stage 17 in the event of such communication. Processing stage 17 is further arranged to receive a third influencing signal I3 by means of which processing stage 17, as a result of the third influencing signal I3 being interrogated and analyzed, is arranged to be influencable under programmed control in respect of its ability to communicate, this being done by making communication with memory means 15 and calculating stage 17A possible or not possible as a function of the third influencing signal I3. Processing stage 17 is also arranged to receive the processing clock-signal CLK1, and for the internal processing of the communications data CD, the memory data MD and the calculation data DD at a speed proportional to the frequency of the processing clock-signals CLK1, in which case a power demand that exists at processing stage 17 is substantially proportional to the frequency of processing clock-signal CLK1. Hence, processing stage 17 is able to be influenced in respect of the speed of the internal processing of the communications data CD, the memory data MD and the calculation data DD, in which case the internal processing at a speed preset by the first processing frequency causes a first processing power demand at processing stage 17, and in which case the internal processing at a speed preset by the second processing frequency causes a second processing power demand at processing stage 17 that is higher than the first processing power demand.

The calculating stage 17A is arranged to receive the calculation data DD from processing stage 17 and to process this calculation data DD mathematically in mathematical operations and to transmit result data RD representing the result of such mathematical processing to processing stage 17. Calculating stage 17A is further arranged to receive the calculating clock-signals CLK2 and to process the calculation data DD at a speed proportional to the frequency of the calculating clock-signals CLK2. Hence calculating stage 17A can be influenced in respect of the speed of the mathematical processing of calculation data DD. As a result of the reception of the calculating clock-signal CLK2 of the calculating frequency, a calculating power demand is caused at calculating stage 17A. In the event of the oscillator stage in the calculating clock-signal generating means 14 being in the stopped state, calculating stage 17A causes a calculating stage quiescent power demand that is lower than the calculating power demand.

The data carrier 1 having entered the communications area of the communications station, as soon as the value of supply voltage VDD exceeds the reset supply voltage value UR, the internal processing of data CD, MD, RD or DD is started at processing stage 17 and calculating stage 17A with the help of reset signal R. If, after this, the power made available by power supply means 8 drops below the minimum value, or in other words as soon as the value of supply voltage VDD drops below the reset supply voltage value UR, the processing of data CD, MD, DD or RD is abruptly terminated at processing stage 17 with the help of the reset signal R, without any loss of data occurring due to a lack of power because the data carrier 1 has, in accordance with the invention, influencing means 18 that are provided to influence the data processing means 16 in respect of their mode of processing, namely in respect of their speed of processing and their ability to communicate, in the light of the power available at the power supply means 8.

For this purpose, the influencing means 18 have a first monitoring stage 19 that is arranged to monitor a first parameter of the power supply means 8, which first parameter represents the power available at the power supply means 8 in the first field strength range H1 and which first parameter is formed by the supply voltage VDD. The first monitoring stage 19 is arranged to emit a first monitoring result signal O1 that represents a result of the monitoring process.

The influencing means 18 also have second monitoring stage 20 that is arranged to monitor a second parameter of the power supply means 8, which second parameter represents the power available at the power supply means in the second field strength range H2 and which second parameter is formed by the limiting current IL. The second monitoring stage 20 is arranged to emit a second monitoring result signal O2 that represents a result of the monitoring process.

The influencing means 18 further have a decision-making stage 21 that is implemented in the form of a logic circuit and that is arranged to decide whether the data processing means need to be influenced in respect of their mode of processing on the basis of the monitored parameter IL or VDD. For this purposes the decision-making stage 21 is arranged to receive the first monitoring result signal O1 and to receive the second monitoring result signal O2 and, on the basis of these two monitoring result signals O1 and O2, to generate and emit the first influencing signal Ii, the second influencing signal I2 and the third influencing signal I3. The influencing means 18 are therefore arranged to influence the data processing means 16 in respect of the speed of the internal processing of data CD, MD, DD and RD by means of the first influencing signal I1. The influencing means 18 are therefore further arranged to influence the data processing means 16 in respect of the speed of the mathematical processing of the calculation data DD by means of the second influencing signal 12. Also, the influencing means 18 are arranged to influence the ability of the data processing means 16 to communicate by means of the third influencing signal I3.

For the purpose of monitoring the limiting current IL, the first monitoring stage 19 is implemented in the form of a current comparator circuit, which current comparator circuit has a first transistor 22 and a second transistor 23 and a comparison current source 24. The comparison current source 24 is arranged to generate and emit a comparison current IC. The first transistor 22 and the second transistor 23 and the comparison current source 24 are so connected to one another and to the power supply means 8 that the monitoring result signal O1 represents the result of a comparison of the value of limiting currents IL with the value of comparison current IC.

For the purpose of monitoring the supply voltage VDD, the second monitoring stage 20 has a voltage comparator circuit 25 and a comparison voltage source 26, which comparison voltage source 26 is implemented in the form of a reference voltage source that is arranged to generate and emit a comparison voltage VC that is of a comparison voltage value UC relative to the reference potential GND. The voltage comparator circuit 25 and the comparison voltage source 26 are so connected to one another and to the power supply means 8 that the second monitoring result signal O2 represents the result of a comparison of the value of the supply voltage VDD with the value of the comparison voltage VC.

The operation of the data carrier 1 shown in FIG. 1 will now be elucidated by reference to FIG. 3 in the context of an example of application of the data carrier 1. In this example of application it is assumed that a user (not shown in FIG. 3) who is moving in the direction of a first arrow 27 uses one hand to move the data carrier 1 through a three-dimensional communications area 28 of the communications device along a first path of movement 29, in the direction of a second arrow 29A, in order to allow non-contacting communication between the data carrier 1 and the communications station and in so doing to alter the memory data MD stored in memory means 15, which memory data MD represents transport credit.

It will also be assumed that the value of the comparison current IC is so selected that—once the value of the limiting current IL is higher than that of the comparison current IC—no loss of data can occur due to incomplete processing of data CD, MD, DD or RD, that is to say not even if the data carrier 1 is moved out of the communications area 28 at the maximum speed of the movement that the user can possibly produce.

In FIG. 3, the communications area 28 and a communications coil panel 30 that has a communications coil 31 belonging to the communications device are shown schematically. By means of the communications coil 31, signals S can be generated or received within the communications area 28.

Within the communications area 28, the first range H1 of field strength H exists between a first range boundary 32 that is shown schematically as a first boundary line and a second range boundary 33 that is shown schematically as a second boundary line. Within the communications area 28, there also exists the second range H2 of field strength H between the second range boundary 33 and a boundary face 34 of the communications coil panel 30. Within the communications area 28, the field strength H is at its maximum field strength value HM at a point of origin 35 and is at its reset field strength value HR along the first range boundary 32. Starting from the first range boundary 32 and moving towards the point of origin 35, the value of the field strength H follows the curve shown in FIG. 2A, in which case the distance DSC between the data carrier 1 and the communications station has to be determined as the distance between the point of origin 35 and the position at the time of the data carrier 1 along the first path of movement 29. The first path of movement 29 is favorable in respect of the supply of circuit 2 with power because the data carrier 1 is brought relatively close to the communications coil panel 30 and is also moved in the immediate vicinity thereof for a relatively long time.

When the data carrier 1 is introduced into the communications area 28 the internal processing of data CD, MD, DD or RD is started because the power supply means 8 make available just the amount of power by which the value of the supply voltage VDD exceeds the reset supply voltage value UR.

If the data carrier 1 continues to move as far as a point P1, the field strength H reaches a first field strength value HP1 that is entered in FIG. 2A and that is higher than the reset field strength value HR. However, at this point P1 the value of the supply voltage VDD is lower than the value of the comparison voltage VC and as a result the influencing means 18 influence the data processing means 16, as from the start of the internal processing, as follows:

Firstly, processing stage 17 is influenced in such a way in respect of the speed of the internal processing of data CD, MD, DD or RD that the internal processing takes place in accordance with the speed preset by the first processing frequency. Secondly, processing stage 17 is influenced in such a way in respect of its ability to communicate that communication with memory means 15 and calculating stage 17A is not possible. Calculating stage 17A too is influenced, being influenced in respect of the speed of the mathematical processing of the calculation data DD to the effect that the oscillator stage in the calculation clock-signal generating means 14 is controlled to its stopped state.

This gives the advantage that, with the help of processing stage 17, the internal processing of data CD, MD, DD and RD has been made possible, in which case the communications data CD can where appropriate be communicated to the modulating/demodulating means 12 and, as a result of such communication, memory data MD and/or calculation data DD can, where appropriate, be prepared for the purpose of subsequent communication to the memory means 15 or the calculating stage 17A. However, what is ensured at the same time is that the power supply means 8 merely have to satisfy a basic power demand from circuit 2, which basic power demand is formed in essence by the first processing power demand and the memory means quiescent power demand and the calculating means quiescent power demand, and that a power demand that exceeds the power made available by the power supply means 8 cannot be caused, which power demand would, without the influencing means 18 according to the invention, be caused by the writing power demand or by the calculating power demand and would result in the value of the supply voltage VDD dropping below the reset supply voltage value UR and hence in an unwanted termination of the internal processing of data CD, MD, DD or RD caused by a lack of power. This is particularly important when for example the data carrier 1 is moved on inside the communications area 28 from point 1 not in the direction of rising values of the field strength H—i.e. towards point 2—which would mean a continuous rise in the power available, but in the direction of falling values of field strength H, which is indicated schematically by a second path of movement 36. The second path of movement 36 is considerably less favorable than the first path of movement 29 from the point of view of circuit 2 being supplied with power because in this case the maximum power available already exists at point P1 and once data carrier 1 leaves point P1 behind as it moves along the second path of movement 36, it becomes impossible for the memory data MD to be successfully written or the calculation data DD to be successfully calculated.

Only if the data carrier 1 moves on along the first path of movement 29 away from the first point P1 towards the second point P2 will the power supply means 8 make available sufficient power for the value of the supply voltage VDD to rise above the value of the comparison voltage VC, because the field strength H prevailing at the second point P2 is of a second field strength value HP2 that is higher than the field strength value HUC corresponding to the value UC of the comparison voltage. From that point in time on at which the value of the supply voltage VDD rises above the value of the comparison voltage UC, the processing stage 17 will be so influenced in respect of the speed of the internal processing of data CD, MD, DD or RD that the internal processing will take place in accordance with the speed preset by the second processing frequency, that is to say at a maximum speed of processing.

This gives the advantage that, even though the internal processing takes place at the maximum speed of processing, the unwanted termination of internal processing of data CD, MD, DD or RD due to a lack of power can be reliably avoided even in this case, which lack of power could, without the influencing means 18, occur in a similar way to that explained above in connection with the second path of movement 36 if the data carrier 1 were to move along a third path of movement 37 when memory data MD was to be written or calculation data DD calculated.

Only if data carrier 1 is moved on from point P2 towards point P3 do the power supply means 8 make available sufficient power for the value of the limiting current IL to exceed the value of the comparison current IC because the field strength H prevailing at point P3 is of a third field strength value HP3 that is higher than a field strength value HIC corresponding to the value of the comparison current IC. From that point in time on at which the value of the limiting current IL rises above the value of the comparison current IC, the processing stage 17 is so influenced in respect of its ability to communicate that communication becomes possible with memory means 15 and calculating stage 1 7A. Also, calculating stage 17A is influenced with respect to the speed of the mathematical processing of the calculation data DD to the effect that the oscillator stage of the calculation clock-signal processing means 14 is started.

Hence it is only as from this point in time that memory data MD representing transport credit can be altered with the help of the data processing means 16 on the basis of the communications data CD communicated between the communications station and data carrier 1. This gives the advantage that it is only as from this point in time that cryptographic mathematical operations that are provided and required for the purpose of authentication in connection with the communication of memory data MD are in fact performed on the calculation data DD by means of calculating stage 17A, and that as a result of such mathematical processing of the calculation data DD the result data RD is in fact emitted, because the power made available by the power supply means 8 is adequate for successful completion of the mathematical processing of the calculation data DD. It also gives the advantage that it is only as from this point in time that the writing of the memory data MD is actually performed because it is ensured that the power required for successful completion of the writing of the memory data to the memory means 15 is made available by the power supply means. It also gives the advantage that—because of the value selected for the comparison current IC—it is ensured from this point in time on that even if there is for a short time a limiting current IL whose value exceeds the value of the comparison current IC any lack of power caused by the speed of movement of the data carrier 1 will certainly be prevented, and that the data carrier 1 can thus be moved out of the communications area 28 even at the maximum speed of movement that the user is capable of producing without there being any danger of data being lost due to lack of power. Hence even a movement of the data carrier 1 along a fourth path of movement 38 does not present any problem with regard to an adequate supply of power to circuit 2 even though the dwell time within an area of adequate field strength is considerably shorter than it is in the case of a movement along the first path of movement 29. Hence there is implemented in the data carrier 1 a predictive influencing of the data processing means 16 in respect of its mode of processing in the light of the power available at the power supply means 8.

It may be mentioned that the influencing means 18 may also be arranged to influence the ability of the data processing means 16 to communicate with the modulating/demodulating means 12 in order, during the amplitude modulation, to avoid any modulation-induced reduction in the power made available by power supply means 8.

It may be mentioned that instead of the comparison current source 24 the influencing means 18 may have a resistor so that the first monitoring signal O1 transmitted to the decision stage 21 is proportional to the limiting current IL. Provision may also be made for a second monitoring signal O2 proportional to the supply voltage VDD to be fed to the decision-making stage 21. It has proved to be particularly advantageous in this connection if the decision-making means 21 have at least one analog/digital converter by means of which the values of the two monitoring signals O1 and O2 can be acquired. This gives the advantage that the speed of processing for example can be influenced continuously.

It may further be mentioned that the influencing means 18 may also be arranged to receive information specifying the mode of processing of the data processing means 16 at the time, and that this information may be considered in the making of the decision as to whether, on the basis of the monitored parameter, the data processing means 16 need to be influenced in respect of their mode of processing.

It may also be mentioned that the power supply means 8 may be arranged not to have a supply voltage limiting stage 10, thus enabling only the supply voltage VDD to be allowed for as a single parameter. It may also be mentioned in connection with the power supply means 8 that the supply voltage limiting stage 10 may also be arranged on the output side of the supply voltage generating stage 9.

It may further be mentioned that the calculation clock-signal generating means 14 may be arranged to vary the calculating frequency of the calculating clock-signal CLK2 continuously or in steps as a function of the second influencing signal I2.

It may further be mentioned that processing stage 17 may be influencable in respect of its ability to communicate by means of the third influencing signal I3 in such a way that, although it is possible for the memory data MD to be read out of the memory means 15, it is at the same time not possible for memory data MD to be transmitted to memory means 15 for the purpose of enabling such memory data MD to be written. This is of advantage particularly when there is a significant difference between these two processes in respect of the power demand that memory means 15 make.

1. A data carrier having transmission means for transmitting signals and having a circuit, which circuit has at least one connection to which the transmission means are connected, and which circuit has the parts listed below, namely: power supply means that, using a signal occurring at the transmission means, are arranged to supply the parts of the circuit with power, and data processing means that are provided for the processing of data in at least two different modes of processing and by means of which data is able to be processed when the power made available by the power supply means exceeds a minimum value, the power made available by the power supply means being dependent on the mode of processing being performed at the time, characterized in that influencing means are provided that are provided for influencing the data processing means in respect of their mode of processing in the light of the power available at the power supply means.

2. A data carrier as claimed in claim 1, characterized in that the influencing means are arranged to influence the data processing means in respect of the speed of processing of data.

3. A data carrier as claimed in claim 1, characterized in that the influencing means are arranged to influence the data processing means in respect of the latter's ability to communicate with parts of the circuit provided for communication with the data processing means.

4. A data carrier as claimed in claim 1, characterized in that the influencing means are arranged to monitor at least one parameter of the power supply means, which parameter represents the power available at the power supply means, and in that the influencing means are arranged to decide whether, on the basis of the parameter monitored, the data processing means need to be influenced in respect of their mode of processing.

5. Circuit for a data carrier, which data carrier has transmission means for transmitting signals, which circuit has at least one connection, to which connection the transmission means can be connected, and which circuits has the parts listed below, namely:
power supply means that, using a signal occurring at the transmission means, are arranged to supply the components of the circuit with power, and data processing means that are provided for the processing of data in at least two different modes of processing and by means of which data can be processed when the power made available by the power supply means exceeds a minimum value, the power made available by the power supply means being dependent on the mode of processing being performed at the time, characterized in that influencing means are provided that are provided for influencing the data processing means in respect of their mode of processing in the light of the power available at the power supply means.

6. A circuits as claimed in claim 5, characterized in that the influencing means are arranged to influence the data processing means in respect of the speed of processing of data.

7. A circuit as claimed in claim 5, characterized in that the influencing means are arranged to influence the data processing means in respect of the latter's ability to communicate with parts of the circuit provided for communication with the data processing means.

8. A circuit as claimed in claim 5, characterized in that the influencing means are arranged to monitor at least one parameter of the power supply means, which parameter represents the power available at the power supply means, and in that the influencing means are arranged to decide whether, on the basis of the parameter monitored, the data processing means need to be influenced in respect of their mode of processing.

9. A circuit as claimed in claim 5, characterized in that the circuit is implemented in the form of an integrated circuit.
